(19) United States
(12) Patent Application Publication
(10) Pub. No.: US 2020/0109942 A1
(43) Pub. Date: Apr. 9, 2020

(54) ARC PROCESSING DEVICE AND METHOD USING THE SAME

(71) Applicant: INDUSTRIAL TECHNOLOGY RESEARCH INSTITUTE, Hsinchu (TW)

(72) Inventors: Chung-Min CHANG, Taichung City (TW); Shih-Chang LIANG, Changhua City (TW); Yu-Sheng TSENG, Taichung City (TW); Meng-Chiu LIN, Taichung City (TW); Shih-Che HSU, Huwei Township (TW)

(73) Assignee: INDUSTRIAL TECHNOLOGY RESEARCH INSTITUTE, Hsinchu (TW)

(21) Appl. No.: 16/213,039

(22) Filed: Dec. 7, 2018

(30) Foreign Application Priority Data
Oct. 9, 2018 (TW) 107135647

(51) Int. Cl. G01B 21/22; G06K 9/00; G05B 19/402

(52) U.S. Cl. CPC G01B 21/22; G06K 9/00523; G05B 2219/36342; G05B 2219/35205; G05B 19/402

(57) ABSTRACT

An arc processing method is provided. Firstly, a machining program code is provided, wherein the machining program code includes a control code for machining an arc having a start point and an end point. Then, the machining program code is analyzed to obtain a first start point vector and a first end point vector, both defined by a first coordinate system, of a tool. Then, the first start point vector is converted to a second start point vector defined by a second coordinate system. Then, the first end point vector is converted to a second end point vector defined by the second coordinate system. Then, a plurality of first interpolation vectors of interpolation points, defined by the second coordinate system and interposed between the second start point vector and the second end point vector, are obtained. Then, all the first interpolation vectors are converted into corresponding second interpolation vectors.

This application claims the benefit of Taiwan application Serial No. 107135647, filed Oct. 9, 2018, the subject matter of which is incorporated herein by reference.

### BACKGROUND OF THE DISCLOSURE

### Field of the Disclosure

The disclosure relates in general to a processing device and a processing method using the same, and more particularly to an arc processing device and an arc processing method using the same.

### Description of the Related Art

The calculation of the tool gesture angle in the multi-dimensional space may increase computation burden and retard computation speed. Particularly, the calculation of the tool gesture angle in the multi-dimensional space may encounter the solution selection problem of the tool. Therefore, it has become a prominent task for the industries to provide a new processing device and a processing method using the same to resolve the above problems.

### SUMMARY OF THE DISCLOSURE

According to an embodiment of the present disclosure, an arc processing method is provided. The arc processing method includes the following steps: the machining program code is analyzed to obtain a first start point vector of a start point tool gesture at a start point of the tool and a first end point vector of an end point tool gesture at an end point of the tool, wherein the first start point vector and the first end point vector are defined by a first coordinate system; the first start point vector is converted to a second start point vector defined by a second coordinate system, wherein the second coordinate system has a first coordinate axis and a second coordinate axis, and the arc is located on a plane formed by the first coordinate axis and the second coordinate axis; the first end point vector is converted to a second end point vector defined by the second coordinate system; a plurality of first interpolation vectors of interpolation points between the second start point vector and the second end point vector are obtained, wherein the first interpolation vectors are defined by the second coordinate system; and the first interpolation vectors is converted to a plurality of second interpolation vectors defined by the first coordinate system.

According to another embodiment of the present disclosure, an arc processing device is provided. The arc processing device includes a machining code analyzer, a coordinate converter and an interpolation vector obtainer. The machining code analyzer is configured to analyze the machining program code to obtain a first start point vector of a start point tool gesture at a start point of the tool and a first end point vector of an end point tool gesture at an end point of the tool, wherein the first start point vector and the first end point vector are defined by a first coordinate system. The coordinate converter is configured to convert the first start point vector to a second start point vector defined by a second coordinate system and convert the first end point vector to a second end point vector defined by the second coordinate system, wherein the second coordinate system has a first coordinate axis and a second coordinate axis, and the arc is located on a plane formed by the first coordinate axis and the second coordinate axis. The interpolation vector obtainer is configured to obtain a plurality of first interpolation vectors of interpolation points between the second start point vector and the second end point vector, wherein the first interpolation vectors are defined by the second coordinate system. The coordinate converter is further configured to convert the first interpolation vectors into a plurality of second interpolation vectors defined by the first coordinate system.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a functional block diagram of an arc processing device according to an embodiment of the disclosure.

FIG. 2 is a schematic diagram of the arc processing device of FIG. 1 used in a tool machine.

FIG. 3 is a flowchart of an arc processing method according to an embodiment of the disclosure.

FIG. 4 is a schematic diagram of coordinate conversion according to an embodiment of the disclosure.

FIG. 5 is a vector superposition diagram of the vectors of FIG. 4 including the start point tool gesture at a start point, the end point tool gesture at an end point and the interpolation point tool gesture at an interpolation point.

### DETAILED DESCRIPTION OF THE DISCLOSURE

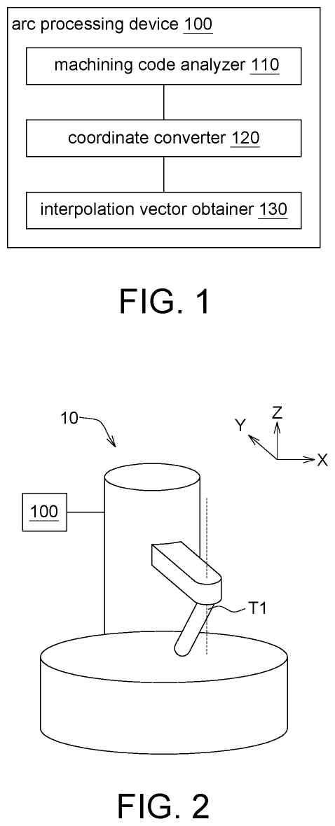

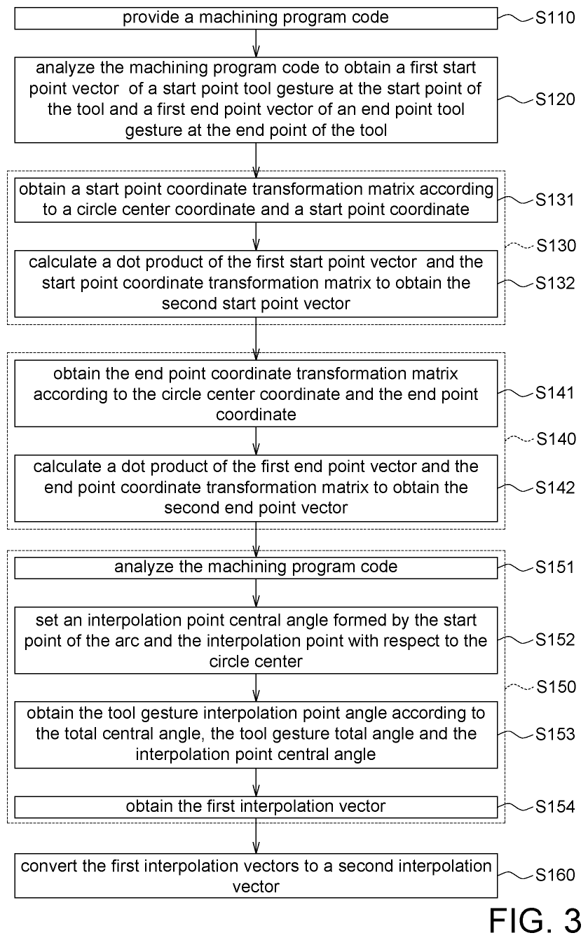

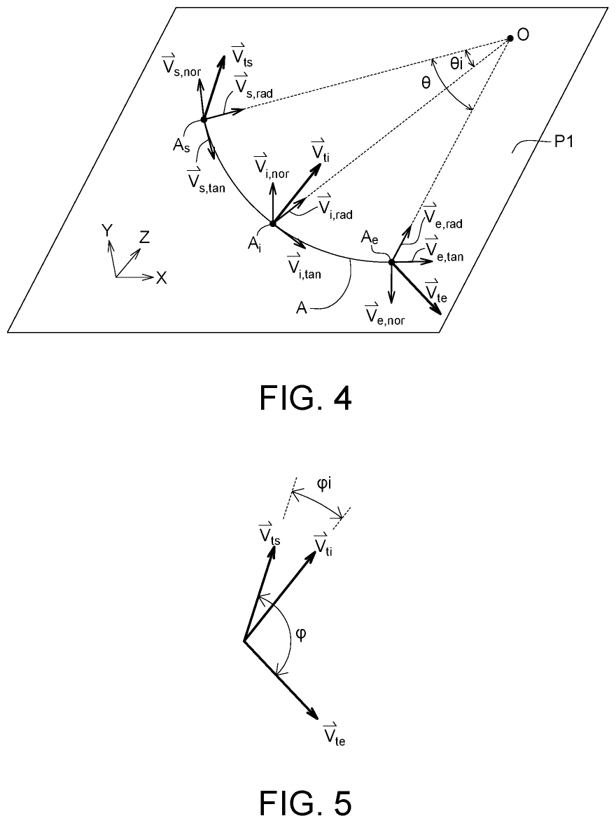

Refer to FIGS. 1-5. FIG. 1 is a functional block diagram of an arc processing device 100 according to an embodiment of the disclosure. FIG. 2 is a schematic diagram of the arc processing device 100 of FIG. 1 used in a tool machine 10. FIG. 3 is a flowchart of an arc processing method according to an embodiment of the disclosure. FIG. 4 is a schematic diagram of coordinate conversion according to an embodiment of the disclosure. FIG. 5 is a vector superposition diagram of the vectors of FIG. 4 including a start point tool gesture \vec{V}ₜₛ at a start point As, the end point tool gesture \vec{V}ₜₑ at an end point Ae and an interpolation point tool gesture \vec{V}ₜᵢ at an interpolation point Ai. The symbols of FIGS. 4 and 5 indicate that the start point tool gesture \vec{V}ₜₛ, the end point tool gesture \vec{V}ₜₑ and the interpolation point tool gesture \vec{V}ₜᵢ are vectors.

As indicated in FIG. 1, the arc processing device 100 includes a machining code analyzer 110, a coordinate converter 120 and an interpolation vector obtainer 130. The machining code analyzer 110, the coordinate converter 120 and/or the interpolation vector obtainer 130 can be realized by circuits formed by the semiconductor manufacturing process or integrated to the software or firmware of a processor. At least two of the machining code analyzer 110, the coordinate converter 120 and the interpolation vector obtainer 130 can be integrated as one element, such as a controller, or integrated to the controller of the tool machine 10 (not illustrated). As indicated in FIG. 2, the arc processing device 100 can be adapted in the tool machine 10, such as a five-axis machine tool. That is, depending on machining needs, a tool T1 configured on the tool machine 10 can be translated along the X-axis, the Y-axis and the Z-axis, or can rotate around the Y-axis (that is, the B-axis) and/or the Z-axis (that is, the C-axis).

The arc processing method of the arc processing device 100 of FIG. 1 is described with the flowchart of FIG. 3.

In step S110, a machining program code NC is provided. The machining program code NC includes a control code for machining an arcA by a tool. The arc A includes a start point coordinate of a start point As, an end point coordinate of an end point Ae, and a circle center coordinate of a circle center O of the arc A. Additionally, the machining program code NC defines the start point coordinate, the end point coordinate and the circle center coordinate by a first coordinate system W. The first coordinate system W can be realized by a Cartesian coordinate system, such as the XYZ coordinate system of FIG. 4, representing the coordinates of a workpiece. As indicated in FIG. 4, the plane P1 on which the arc A is located can form any angle with anyone of the X-axis, the Y-axis and the Z-axis of the first coordinate system W. Besides, the arc A can be at least a part of the boundary line of a tangent plane formed by the plane P1 and a sphere or a cylinder.

Let the machining program code NC of exemplary example 1 be taken for example. The control code “G43.4” is for controlling the tool gesture in five-axis machining process, wherein “H01” represents the selected tool. The control code “G90G01X100 Y200 Z50B-20C0” represents the machining information of the start point As, wherein the parameters “X100”, “Y200” and “Z50” represent the start point coordinate [100, 200, 50] of the start point As (represented by the first coordinate system W), the parameters “B-20” and “C0” represent the angles at which the tool T1 rotates around the Y-axis (the numeric value following parameter B is referred as the tilt angle) and the Z-axis (the numeric value following parameter C is referred as the rotation angle), respectively. The control code “G03G17X200Y500I-400J300B-30C60” represents the information of machining the arc (G03) up to the end point Ae, wherein the parameters “X200” and “Y500” represent the end point coordinate [200, 500, 50] of the end point Ae (represented by the first coordinate system W). The parameter “G17” of exemplary example 1 represents machining an arc A on the XY plane, therefore the Z-axis coordinate value of the end point coordinate is the same as the Z-axis coordinate value of the start point coordinate. However, the embodiments of the disclosure are not limited thereto. For example, the arc A can be defined in a three-dimensional XYZ space. Additionally, the parameters “I-400” and “J300” of the machining program code NC respectively represent displacements from the circle center O of the arc A towards the X-axis and the Y-axis with respect to the start point As (represented by the first coordinate system). The control code “G49” represents terminating the five-axis machining process.

### Exemplary Example 1

G43.4 H01

G90G01X100 Y200 Z50B-20C0 F1000

G03G17X200Y500I-400J300B-30C60

G49

In step S120, as indicated in FIG. 4, the machining code analyzer 110 analyzes the machining program code NC to obtain a first start point vector \vec{V}_{ts,W} of a start point tool gesture \vec{V}ₜₛ at the start point As of the tool T1 and a first end point vector \vec{V}_{te,W} of an end point tool gesture \vec{V}ₜₑ at the end point Ae of the tool T1, wherein the first start point vector \vec{V}_{ts,W} and the first end point vector \vec{V}_{te,W} are defined by the first coordinate system W.

There are many methods for obtaining the first start point vector \vec{V}_{ts,W}, and the disclosure is exemplified by one of the methods.

For example, the machining code analyzer 110 obtains the first start point vector \vec{V}_{ts,W} by the forward kinematic theory according to a tilt angle B and a rotation angle C. To put it in greater details, the first start point vector \vec{V}_{ts,W} can be obtained according to equations (1a)˜(1d). The parameters B and C of equations (1b)˜(1d) respectively represent the tilt angle and the rotation angle obtained from the machining program code NC. Furthermore, the numeric value “−20” of the parameter “B-20” of the machining program code NC of exemplary example 1 can be substituted to the tilt angle B of equations (1b)˜(1d), and the numeric value “0” of the parameter “C0” can be substituted to the rotation angle C of the equations (1b)˜(1d). Moreover, the parameters V_{ts,i}, V_{ts,j} and V_{ts,k} of equation (1a) respectively represent the components of the first start point vector \vec{V}_{ts,W} on the X-axis, the Y-axis and the Z-axis of the first coordinate system W.

\vec{V}_{ts,W}=[V_{ts,i},V_{ts,j},V_{ts,k}] (1a)

V_{ts,i}=−sin(B)cos(C) (1b)

V_{ts,j}=−sin(B)sin(C) (1c)

V_{ts,k}=−cos(B) (1d)

According to equations (1a)˜(1d), the first start point vector \vec{V}_{ts,W} obtained by the machining program code NC of exemplary example 1 can be expressed as: \vec{V}_{ts,W}=[−sin(−20)cos(0),−sin(−20)sin(0),−cos(−20)]=[0.342, 0, −0939].

Similarly, the first end point vector \vec{V}_{te,W} of equation (2a) can be obtained according to equations (1b)˜(1d). The parameters V_{te,i}, V_{te,j} and V_{te,k} of equation (2a) respectively represent the components of the first end point vector \vec{V}_{te,W} on the X-axis, the Y-axis and the Z-axis of the first coordinate system W. The first end point vector \vec{V}_{te,W} obtained by the machining program code NC of exemplary example 1 can be expressed as: \vec{V}_{te,W}=[−sin(−30) cos(60),−sin(−30) sin(60),−cos(−30)]=[0.25, 0.433, −0866].

\vec{V}_{te,W}=(V_{te,i},V_{te,j},V_{te,k}) (2a)

In step S130, the coordinate converter 120 converts the first start point vector \vec{V}_{ts,W} to a second start point vector \vec{V}_{ts,R}. The second start point vector \vec{V}_{ts,R} is defined by a second coordinate system R, such as a circumferential coordinate system. The second coordinate system R has a first coordinate axis and a second coordinate axis. The arc A is located on a plane P1 formed by the first coordinate axis and the second coordinate axis. The first coordinate axis is such as a radial coordinate axis of the start point As (that is, the vector \vec{V}_{s,rad} from the start point As towards the circle center O as indicated in FIG. 4), the second coordinate axis is such as a tangent direction coordinate axis of the start point As (that is, the vector \vec{V}_{s,tan} of FIG. 4). Besides, the second coordinate system R further has a third coordinate axis. The third coordinate axis, such as a normal direction coordinate axis of the start point As (such as the vector \vec{V}_{s,nor} of FIG. 4), is perpendicular to the first coordinate axis and the second coordinate axis (that is, perpendicular to the plane P1).

There are many methods for the coordinate converter 120 to convert the first start point vector \vec{V}_{ts,W} to the second start point vector \vec{V}_{ts,R}, and one of the methods is described below using steps S131˜S132.

In step S131, the coordinate converter 120 obtains a start point coordinate transformation matrix Mₛ according to the circle center coordinate and the start point coordinate obtained by the machining program code NC, wherein the start point coordinate transformation matrix Mₛ is expressed as: Mₛ=[\vec{V}_{s,rad} [symbol] \vec{V}_{s,tan} [symbol] \vec{V}_{s,nor}] and is configured to convert the first start point [symbol] vector \vec{V}_{ts,W} to the second start point vector \vec{V}_{ts,R}. Furthermore, since the parameters I and J of the machining program code NC respectively represent the X-axis component and the Y-axis component of the arc A from the start point As to the circle center O, the vector from the start point As to the circle center O can be obtained from the parameters I and J of the machining program code NC, such that the start point coordinate transformation matrix Mₛ can be obtained accordingly.

Let the machining program code NC of exemplary example 1 be taken for example. The numeric value “−400” of the parameter “I-400” represents the X-axis component of the arc A from the start point As to the circle center O, and the numeric value “300” of the parameter “J300” represents the Y-axis component of the arc A from the start point As to the circle center O. Thus, the vector from the start point As to the circle center O, which can be expressed as: [−400, 300, 0] (represented by the first coordinate axis W), is converted to a unit vector of [−0.8, 0.6, 0], that is, \vec{V}_{s,rad}. The conversion of the said unit vector is:

$$[ \frac{- 400}{\sqrt{{( - 400 )}^{2} + {( 300 )}^{2}}} , \frac{300}{\sqrt{{( - 400 )}^{2} + {( 300 )}^{2}}} , 0 ] .$$

According to the restriction that \vec{V}_{s,tan}, \vec{V}_{s,rad} and \vec{V}_{s,nor} are orthogonal to each other, the vectors \vec{V}_{s,tan} and \vec{V}_{s,nor} can be obtained as \vec{V}_{s,tan}=[0.6, 0.8, 0] and \vec{V}_{s,nor}=[0, 0, 1]. The vectors \vec{V}_{s,tan}, \vec{V}_{s,rad} and \vec{V}_{s,nor}, and the start point coordinate transformation matrix Mₛ obtained from the above equations can be expressed as the following equation (3).

$${M}_{s} = [ {\vec{V}}_{s , rad} , {\vec{V}}_{s , tan} , {\vec{V}}_{s , nor} ] = [ \begin{matrix}- 0.8 & 0.6 & 0 \\ 0.6 & 0.8 & 0 \\ 0 & 0 & 1\end{matrix} ] \qquad ( 3 )$$

In step S132, the coordinate converter 120 calculates a dot product of the first start point vector \vec{V}_{ts,W} and the start point coordinate transformation matrix Mₛ to obtain the second start point vector \vec{V}_{ts,R} according to equation (4). For example, the second start point vector \vec{V}_{ts,R} obtained by the machining program code NC of exemplary example 1 according to equation (4) can be expressed as: \vec{V}_{ts,R}=[0.342, 0, −0.939]·Mₛ=[0.273,0.205,−0.939], wherein the numeric value of Mₛ is illustrated in equation (3).

\vec{V}_{ts,R}=\vec{V}_{ts,W}·Mₛ (4)

In step S140, the coordinate converter 120 converts the first end point vector \vec{V}_{te,W} to a second end point vector \vec{V}_{te,R} defined by the second coordinate system R. The first coordinate axis of the second end point vector \vec{V}_{te,R} is such as the radial coordinate axis of an end point Ae (that is, the vector from the end point Ae towards the circle center O, such as the vector \vec{V}_{e,rad} of FIG. 4), and the second coordinate axis is such as a tangent direction coordinate axis of the end point Ae (such as the vector \vec{V}_{e,tan} of FIG. 4). Besides, the second coordinate system R further has a third coordinate axis. The third coordinate axis, such as the normal direction coordinate axis of the end point Ae (such as the vector \vec{V}_{e,nor} of FIG. 4), is perpendicular to the first coordinate axis and the second coordinate axis (that is, perpendicular to the plane P1).

There are many methods for the coordinate converter 120 to convert the first end point vector \vec{V}_{te,W} to the second end point vector \vec{V}_{te,R}, and one of the methods is described below using steps S141˜S142.

In step S141, the coordinate converter 120 obtains the end point coordinate transformation matrix Mₑ according to the circle center coordinate and the end point coordinate obtained from the machining program code NC, wherein the end point coordinate transformation matrix Mₑ is expressed as: Mₑ=[\vec{V}_{e,rad},\vec{V}_{e,tan},\vec{V}_{e,nor}] and is configured to convert the first end point vector \vec{V}_{te,W} to the second end point vector \vec{V}_{te,R}. The vector from the end point Ae to the circle center O can be obtained from the circle center coordinate and the end point coordinate obtained by the machining program code NC, such that the end point coordinate transformation matrix Mₑ can be obtained accordingly.

Let the machining program code NC of exemplary example 1 be taken for example. It can be obtained from the start point coordinate [100, 200, 50] of the start point As and the parameters “I-400” and “J300” that the circle center coordinate of the circle center O is: [300, 500, 50]. According to the circle center coordinate of the circle center O and the end point coordinate, the vector [−500, 0, 0] (represented by in the first coordinate system W) from the end point Ae to the circle center O is converted to a unit vector [−1, 0, 0], that is, the vector \vec{V}_{e,rad}. According to the restriction that the vectors \vec{V}_{e,tan}, \vec{V}_{e,rad} and \vec{V}_{e,nor} are orthogonal to each other, it can be obtained that vectors \vec{V}_{e,rad} and \vec{V}_{e,nor} can be expressed as: \vec{V}_{e,rad}=[0, 1, 0], \vec{V}_{e,nor}=[0, 0, 1]. The start point coordinate transformation matrix Mₑ can be expressed as equation (5).

$${M}_{e} = [ {\vec{V}}_{e , rad} , {\vec{V}}_{e , tan} , {\vec{V}}_{e , nor} ] = [ \begin{matrix}- 1 & 0 & 0 \\ 0 & 1 & 0 \\ 0 & 0 & 1\end{matrix} ] \qquad ( 5 )$$

In step S142, the coordinate converter 120 calculates a dot product of the first end point vector \vec{V}_{te,W} and the end point coordinate transformation matrix Mₑ to obtain the second end point vector \vec{V}_{te,R} according to equation (6). For example, the second end point vector \vec{V}_{te,R} obtained by the machining program code NC of exemplary example 1 according to equation (6) can be expressed as: \vec{V}_{te,R}=[0.25,0.433,−0.866]·Mₑ=[−0.25, 0.433, −0.866].

\vec{V}_{te,R}=\vec{V}_{te,W}·Mₑ (6)

In step S150, the interpolation vector obtainer 130 obtains a first interpolation vector \vec{V}_{ti,R} between the second start point vector \vec{V}_{ts,R} and the second end point vector \vec{V}_{te,R} along the arc A. The first interpolation vector \vec{V}_{ti,R} is a vector of the interpolation point tool gesture \vec{V}ₜᵢ of the tool T1 at an interpolation point Ai and is defined by the second coordinate system R.

There are many methods for the interpolation vector obtainer 130 to obtain the first interpolation vector \vec{V}_{ti,R}, and one of the methods is described below using steps S151˜S154.

In step S151, the machining code analyzer 110 analyzes the machining program code NC to obtain a total central angle θ, formed by the start point As and the end point Ae with respect to the circle center O of the arc A, and a tool gesture total angle φ. The total central angle θ and the tool gesture total angle φ respectively are illustrated in FIG. 4 and FIG. 5. The tool gesture total angle φ is an angle formed by the start point tool gesture \vec{V}ₜₛ and the end point tool gesture \vec{V}ₜₑ. In another embodiment, step S151 can be integrated with step S110, and the two steps can be performed concurrently.

In step S152, the interpolation vector obtainer 130 sets an interpolation point central angle θᵢ formed by the start point As of the arc A and the interpolation point Ai with respect to the circle center O. The interpolation point central angle θᵢ is illustrated in FIG. 4. The interpolation point central angle θᵢ is smaller than the interpolation point central angle θ. In practice, the interpolation point central angle θᵢ can be 1/2, 3/4, 1/3, 1/4 or any other ratio of the interpolation point central angle θ. The interpolation point central angle θᵢ can be any angle and is not specified in the embodiments of the disclosure.

In step S153, the interpolation vector obtainer 130 obtains the tool gesture interpolation point angle φᵢ according to the total central angle θ, the tool gesture total angle φ and the interpolation point central angle θᵢ. For example, the interpolation vector obtainer 130 obtains the tool gesture interpolation point angle φᵢ; according to equation (7). As indicated in FIG. 5, the tool gesture interpolation point angle φᵢ is an angle formed by the start point tool gesture \vec{V}ₜₛ and the interpolation point tool gesture \vec{V}ₜᵢ. It can be understood from equation (7) that the ratio of the tool gesture interpolation point angle φᵢ to the tool gesture total angle φ is equivalent to the ratio of the interpolation point central angle θᵢ to the total central angle θ.

$${ϕ}_{i} = \frac{{θ}_{i}}{θ} \times ϕ \qquad ( 7 )$$

In step S154, the interpolation vector obtainer 130 obtains the first interpolation vector \vec{V}_{ti,R} by the plane circular interpolation method according to the second start point vector \vec{V}_{ts,R}, the second end point vector \vec{V}_{te,R}, the tool gesture total angle φ and the tool gesture interpolation point angle φᵢ. To put it in greater details, the first interpolation vectors \vec{V}_{ti,R} can be obtained according to equation (8) or the spherical linear interpolation (Slerp) method. The first interpolation vectors \vec{V}_{ti,R} is defined by the second coordinate system R.

$${\vec{V}}_{ti , R} = \frac{sin ( ϕ - {ϕ}_{i} ) {\vec{V}}_{ts , R} + sin ( {ϕ}_{i} ) {\vec{V}}_{te , R}}{sin ( ϕ )} \qquad ( 8 )$$

The first interpolation vectors \vec{V}_{ti,R} of equation (8) is defined by the second coordinate system R and can be expressed as: \vec{V}_{ti,R}=[V_{ti,r},V_{ti,t},V_{ti,n}]_{R}, wherein Vₜᵢᵣ is a radial component of the first interpolation vector \vec{V}_{ti,R}, Vₜᵢₜ is a tangent direction component of the first interpolation vector \vec{V}_{ti,R}, and Vₜᵢₙ is a normal direction coordinate axis component of the first interpolation vector \vec{V}_{ti,R}. As indicated in FIG. 4, the first interpolation vector \vec{V}_{ti,R} is the vector of the interpolation point tool gesture \vec{V}ₜᵢ represented by the second coordinate system R, and therefore a subscript R is used.

In step S160, the interpolation vector obtainer 130 converts the first interpolation vectors \vec{V}_{ti,R} to a second interpolation vector \vec{V}_{ti,W} defined by the first coordinate system W according to equations (9) and (10). According to equation (9), the interpolation point coordinate transformation matrix Mᵢ converts the first interpolation vectors \vec{V}_{ti,R} to the second interpolation vector \vec{V}_{ti,W}. The vector \vec{V}_{i,rad} of the interpolation point coordinate transformation matrix Mᵢ is the transformation vector of the radial coordinate axis of the second coordinate system R of the interpolation point Ai with respect to the first coordinate system W. The vector \vec{V}_{i,tan} is the transformation vector of the tangent direction coordinate axis of the second coordinate system R of the interpolation point Ai with respect to the first coordinate system W. The vector \vec{V}_{i,nor} is the transformation vector of the normal direction coordinate axis of the interpolation point Ai represented by the second coordinate system R with respect to the first coordinate system W.

Mᵢ=[\vec{V}_{i,rad},\vec{V}_{i,tan},\vec{V}_{i,nor}] (9)

\vec{V}_{ti,W}=\vec{V}_{ti,R}·Mᵢ=[V_{ti,r},V_{ti,t},V_{ti,n}]·Mᵢ (10)

Then, the arc processing device 100, by the kinetic theory or existing techniques, can convert the second interpolation vector \vec{V}_{ti,W} to the machining parameters indicating the translation along the X-axis, the Y-axis and the Z-axis and the angles at which the device rotates around the Y-axis and/or the Z-axis. In the practical process for machining the arc A, the arc processing device 100 firstly performs the arc processing method to obtain the second interpolation vector \vec{V}_{ti,W}. Then, the arc processing device 100 machines the arc A on the workpiece according to the machining program code NC and the said machining parameters. In an embodiment, the arc processing device 100 can choose not to add the newly converted machining parameters to the machining program code NC or choose to add the newly converted machining parameters the machining program code NC in the form of a program code. Besides, the arc processing device 100 can store the newly converted machining parameters in a storage device (not illustrated) inside or outside the arc processing device 100.

The number of interpolation points is exemplified by 1 in above embodiments. However, in another embodiment, the number of interpolation points can be more than 1, such as any positive integer between 2˜N, wherein N can be 10, 20, 100, 500, 1000 or above. The larger the number of interpolation points, the smoother the machined arc A. According to the embodiments of the disclosure, the three-dimensional coordinates of the machining points are converted to the circumferential coordinates of the plane (such as the plane P1 of FIG. 4), such that the computation time is reduced, the computation speed is increased and the solution selection problem encountered in the generally known processing method can be avoided. Even when the number of interpolation points is many, the arc processing method according to the embodiments of the disclosure embodiment still can be completed quickly. The arc processing method can be performed to machine an arc guide angle, an outward arc surface and a concave arc surface.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An arc processing method configured to obtain an interpolation vector according to a machining program code comprising a control code for machining an arc using a tool having a start point and an end point, wherein the arc processing method comprises:
analyzing the machining program code to obtain a first start point vector of a start point tool gesture at a start point of the tool and a first end point vector of an end point tool gesture at an end point of the tool, wherein the first start point vector and the first end point vector are defined by a first coordinate system;
converting the first start point vector to a second start point vector defined by a second coordinate system, wherein the second coordinate system has a first coordinate axis and a second coordinate axis, and the arc is located on a plane formed by the first coordinate axis and the second coordinate axis;
converting the first end point vector to a second end point vector defined by the second coordinate system;
obtaining a plurality of first interpolation vectors of interpolation points between the second start point vector and the second end point vector, wherein the first interpolation vectors are defined by the second coordinate system; and
converting the first interpolation vectors to a plurality of second interpolation vectors defined by the first coordinate system.

2. The arc processing method according to claim 1, wherein the step of analyzing the machining program code further comprises:
obtaining a tilt angle and a rotation angle of the tool from the machining program code; and
obtaining the first start point vector of the tool gesture according to the tilt angle and the rotation angle.

3. The arc processing method according to claim 1, wherein the step of analyzing the machining program code further comprises:
obtaining a tilt angle and a rotation angle of the tool from the machining program code; and
obtaining the first end point vector of the tool gesture by the forward kinematic theory according to the tilt angle and the rotation angle.

4. The arc processing method according to claim 1, further comprising:
analyzing the machining program code to obtain a circle center coordinate of a circle center of the arc and a start point coordinate of the start point;
the step of converting the first start point vector to a second start point vector further comprises:
obtaining a start point coordinate transformation matrix according to the circle center coordinate and the start point coordinate; and
calculating a dot product of the first start point vector and the start point coordinate transformation matrix to obtain the second start point vector.

5. The arc processing method according to claim 1, further comprising:
analyzing the machining program code to obtain a circle center coordinate of the arc and an end point coordinate of the end point;
the step of converting the first end point vector to a second end point vector further comprises:
obtaining an end point coordinate transformation matrix according to the circle center coordinate and the end point coordinate; and
calculating a dot product of the first end point vector and the end point coordinate transformation matrix to obtain the second end point vector.

6. The arc processing method according to claim 1, further comprising:
analyzing the machining program code to obtain a total central angle, formed by the start point and the end point with respect to a circle center of the arc, and a tool gesture total angle;
the step of obtaining the first interpolation vectors of interpolation points between the second start point vector and the second end point vector further comprises:
setting a plurality of interpolation point central angles formed by the start point of the arc and the interpolation points with respect to the circle center;
obtaining a corresponding tool gesture interpolation point angle of each interpolation point central angle according to the total central angle, the tool gesture total angle and the interpolation point central angles; and
obtaining the corresponding first interpolation vector of each tool gesture interpolation point angle by the plane circular interpolation method according to the second start point vector, the second end point vector, the tool gesture total angle and the tool gesture interpolation point angle.

7. The arc processing method according to claim 6, wherein in the step of obtaining the tool gesture interpolation point angle, the ratio of each tool gesture interpolation point angle to the tool gesture total angle is equivalent to the ratio of the corresponding interpolation point central angle to the total central angle.

8. The arc processing method according to claim 1, wherein the first coordinate system is a Cartesian coordinate system, the second coordinate system is a circumferential coordinate system, the first coordinate axis is a radial coordinate axis of the circumferential coordinate system, and the second coordinate axis is a tangent direction coordinate axis of the circumferential coordinate system.

9. An arc processing device, comprising:
a machining code analyzer configured to:
analyze the machining program code to obtain a first start point vector of a start point tool gesture at a start point of the tool and a first end point vector of an end point tool gesture at an end point of the tool, wherein the first start point vector and the first end point vector are defined by a first coordinate system;
a coordinate converter configured to:
convert the first start point vector to a second start point vector defined by a second coordinate system, wherein the second coordinate system has a first coordinate axis and a second coordinate axis, and the arc is located on a plane formed by the first coordinate axis and the second coordinate axis; and
convert the first end point vector to a second end point vector defined by the second coordinate system; and
an interpolation vector obtainer configured to:
obtain a plurality of first interpolation vectors of interpolation points between the second start point vector and the second end point vector, wherein the first interpolation vectors are defined by the second coordinate system;
wherein, the coordinate converter is further configured to convert the first interpolation vectors into a plurality of second interpolation vectors defined by the first coordinate system.

10. The arc processing device according to claim 9, wherein the machining code analyzer is further configured to:
obtain a tilt angle and a rotation angle of the tool from the machining program code; and
obtain the first start point vector of the tool gesture by the forward kinematic theory according to the tilt angle and the rotation angle.

11. The arc processing device according to claim 9, wherein the machining code analyzer is further configured to:
obtain a tilt angle and a rotation angle of the tool from the machining program code; and
obtain the first end point vector of the tool gesture by the forward kinematic theory according to the tilt angle and the rotation angle.

12. The arc processing device according to claim 9, wherein the machining code analyzer is further configured to analyze the machining program code to obtain a circle center coordinate of a circle center of the arc and a start point coordinate of the start point; in the step of converting the first start point vector to a second start point vector, the coordinate converter is further configured to:
obtain a start point coordinate transformation matrix according to the circle center coordinate and the start point coordinate; and
calculate a dot product of the first start point vector and the start point coordinate transformation matrix to obtain the second start point vector.

13. The arc processing device according to claim 9, wherein the machining code analyzer is further configured to analyze the machining program code to obtain a circle center coordinate of the arc and an end point coordinate of the end point; in the step of converting the first end point vector to a second end point vector, the coordinate converter is further configured to:
obtain an end point coordinate transformation matrix according to the circle center coordinate and the end point coordinate; and
calculate a dot product of the first end point vector and the end point coordinate transformation matrix to obtain the second end point vector.

14. The arc processing device according to claim 9, wherein the machining code analyzer is further configured to analyze the machining program code to obtain a total central angle, formed by the start point and the end point with respect to a circle center of the arc, and a tool gesture total angle; in the step of obtain the first interpolation vectors of interpolation points between the second start point vector and the second end point vector, the interpolation vector obtainer is further configured to:
set a plurality of interpolation point central angles formed by the start point of the arc and the interpolation points with respect to the circle center;
obtain a corresponding tool gesture interpolation point angle of each interpolation point central angle according to the total central angle, the tool gesture total angle and the interpolation point central angles; and
obtain the corresponding first interpolation vector of each tool gesture interpolation point angle by the plane circular interpolation method according to the second start point vector, the second end point vector, the tool gesture total angle and the tool gesture interpolation point angle.

15. The arc processing device according to claim 14, wherein in the step of obtain the tool gesture interpolation point angle, the ratio of each tool gesture interpolation point angle to the tool gesture total angle is equivalent to the ratio of corresponding interpolation point central angles and the total central angle.

16. The arc processing device according to claim 9, wherein the first coordinate system is a Cartesian coordinate system, the second coordinate system is a circumferential coordinate system, the first coordinate axis is a radial coordinate axis of the circumferential coordinate system, and the second coordinate axis is a tangent direction coordinate axis of the circumferential coordinate system.
